(19) United States
(12) Patent Application Publication
(10) Pub. No.: US 2020/0372165 A1
(43) Pub. Date: Nov. 26, 2020

(54) INFORMATION PROCESSING METHOD, SERVER, AND NON-TRANSITORY COMPUTER-READABLE RECORDING MEDIUM RECORDING INFORMATION PROCESSING PROGRAM

(71) Applicant: Panasonic Intellectual Property Management Co., Ltd., Osaka (JP)

(72) Inventors: Yuji OSAKI, Osaka (JP); Masao NONAKA, Osaka (JP)

(21) Appl. No.: 16/830,825

(22) Filed: Mar. 26, 2020

(30) Foreign Application Priority Data
May 20, 2019 (JP) 2019-094608

(51) Int. Cl. G06F 21/62

(52) U.S. Cl. CPC G06F 21/6218; G06Q 10/20

(57) ABSTRACT

A server receives identification information for identifying an equipment and operating information of the equipment corresponding to a predetermined time, permitting a terminal device, if it is determined that the received operating information satisfies a predetermined condition, to refer to log information of the equipment accumulated in the server, the log information corresponding to the identification information corresponding to a time before the predetermined time, and not permitting the terminal device, if it is determined that the received operating information does not satisfy the predetermined condition, to refer to the log information of the equipment accumulated in the server. The predetermined condition is that the predetermined time is included in a predetermined standard period ending at a current time and the received operating information matches operating information included in the log information of the equipment corresponding to a time in the standard period and accumulated in the server.

### FIELD OF THE INVENTION

The disclosure relates to a technique of controlling reference to log information accumulated in an equipment.

### BACKGROUND ART

Today, the Internet of Things (IoT) employed in equipment, such as consumer electronics products, has been used to improve techniques of regularly storing a state of an equipment or data obtained by an equipment in a server via the Internet and of referring to the data stored in a server using an information terminal from a remote place. To refer to the data, the information terminal should designate data of an equipment to be referred to among pieces of data of a plurality of equipment. If an identifier of the equipment is erroneously designated, data of a wrong equipment, which should not be referred to, might be referred to. If a third party bearing an ill intent obtains an identifier without authorization, the data of the equipment might be referred to and leaked by the third party.

Techniques for preventing such information leakage are disclosed, for example, in JP 5831713 B2, JP 6015351 B2, and JP 2007-323520 A.

For example, JP 5831713 B2 discloses a technique of determining permission of access to a content by a user based on information on an owner of the content to which access is requested and information on a family and an acquaintance of the identified user.

For example, JP 6015351 B2 discloses a technique of permitting access to a file if access to the file is ordered and detected information on a current location is within an access-permitted range indicating a range where access to the file by a portable terminal device is permitted.

For example, JP 2007-323520 A discloses a technique of comparing video data received from a client device with the entire or a portion of authentication video data, performing predetermined permit-processing if the compared pieces of data match each other, and performing predetermined no-permit-processing if the compared pieces of data do not match each other.

The conventional techniques however have complexity in managing data used for controlling permission of reference and cannot surely prevent information leakage. Further improvement is yet needed.

### SUMMARY OF THE INVENTION

The disclosure is made to solve the problem described above. An object of the disclosure is to provide a technique that reduces a workload of managing data used for controlling permitting and not permitting reference and also prevents leakage of log information.

An information processing method according to one embodiment of the disclosure is an information processing method for a server to control reference to accumulated log information of an equipment, the information processing method including receiving identification information for identifying the equipment and operating information of the equipment corresponding to a predetermined time, the identification information and the operating information being transmitted from a terminal device connected to the server via a network, determining whether the received operating information satisfies a predetermined condition, permitting the terminal device, if it is determined that the received operating information satisfies the predetermined condition, to refer to the log information of the equipment accumulated in the server, the log information corresponding to the identification information corresponding to a time before the predetermined time, and not permitting the terminal device, if it is determined that the received operating information does not satisfy the predetermined condition, to refer to the log information of the equipment accumulated in the server. The predetermined condition is that the predetermined time is included in a predetermined standard period ending at a current time and the received operating information matches operating information included in the log information of the equipment corresponding to a time in the standard period and accumulated in the server.

### BRIEF DESCRIPTION OF THE DRAWINGS

FIG. 1 illustrates an example configuration of a data reference system according to an embodiment of the disclosure;

FIG. 2 illustrates an example configuration of an equipment according to the embodiment of the disclosure;

FIG. 3 illustrates an example configuration of a terminal device according to the embodiment of the disclosure;

FIG. 4 illustrates an example configuration of a server according to the embodiment of the disclosure;

FIG. 5 is a flowchart for explaining log information accumulation processing according to the embodiment of the disclosure;

FIG. 6 illustrates example table data stored in an operating information storing unit of the equipment according to the embodiment;

FIG. 7 illustrates example table data stored in a log information storing unit of the server according to the embodiment;

FIG. 8 is a first flowchart for explaining reference control processing performed by the data reference system according to the embodiment of the disclosure;

FIG. 9 is a second flowchart for explaining the reference control processing performed by the data reference system according to the embodiment of the disclosure;

FIG. 10 illustrates an example data display screen displayed on a displaying unit of the terminal device of the embodiment;

FIG. 11 is a schematic figure for explaining interpolation processing performed by a data interpolating unit of the embodiment;

FIG. 12 illustrates an example log information display screen displayed on the displaying unit of the terminal device of the embodiment;

FIG. 13 illustrates an example reference-rejected information display screen displayed on the displaying unit of the terminal device of the embodiment;

FIG. 14 illustrates an example manipulation-instructing information display screen displayed on the displaying unit of the terminal device of the embodiment; and

FIG. 15 is a flowchart for explaining reference control processing performed by the server of the embodiment of the disclosure.

### DESCRIPTION OF EMBODIMENTS

Basic Idea of Disclosure

In techniques disclosed in JP 5831713 B2 and JP 6015351 B2, a reference table in which data is previously associated with information necessary for permitting reference needs to be managed. For this reason, in the techniques disclosed in JP 5831713 B2 and JP 6015351 B2, the reference table needs to be updated every time when a reference condition is changed.

Meanwhile, the technique described in JP 2007-323520 A needs not manage a reference table but has difficulty, if leakage of data for authentication has occurred, in preventing reference to data by a person who is not permitted to refer to the data.

To solve the problem described above, the information processing method according to one embodiment of the disclosure is an information processing method for a server to control reference to accumulated log information of an equipment, the information processing method including receiving identification information for identifying the equipment and operating information of the equipment corresponding to a predetermined time, the identification information and the operating information being transmitted from a terminal device connected to the server via a network, determining whether the received operating information satisfies a predetermined condition, permitting the terminal device, if it is determined that the received operating information satisfies the predetermined condition, to refer to the log information of the equipment accumulated in the server, the log information corresponding to the identification information corresponding to a time before the predetermined time, and not permitting the terminal device, if it is determined that the received operating information does not satisfy the predetermined condition, to refer to the log information of the equipment accumulated in the server. The predetermined condition is that the predetermined time is included in a predetermined standard period ending at a current time and the received operating information matches operating information included in the log information of the equipment corresponding to a time in the standard period and accumulated in the server.

According to the configuration, reference to the log information is permitted if the operating information received from the terminal device matches the operating information included in the log information of the equipment corresponding to a time in the standard period and accumulated in the server. This reduces a workload of managing data used for controlling permission of reference. Meanwhile, reference to the log information is permitted if the predetermined time corresponding to the operating information received from the terminal device is included in the predetermined standard period ending at the current time, so that reference to the log information is not permitted after the predetermined standard period has passed. This prevents leakage of log information.

In the information processing method described above, the terminal device may be configured to receive an input of the operating information of the equipment corresponding to the predetermined time, the input being given by an user, the receiving may be receiving of the identification information and the operating information input by the user, and the predetermined condition may be that the predetermined time is included in the predetermined standard period ending at the current time and a difference between the received operating information and the operating information included in the log information of the equipment corresponding to the time in the standard period and accumulated in the server, is within a predetermined range.

In this configuration, the identification information and the operating information input by the user are received, so that the terminal device and the equipment need not communicate with each other. This simplifies the configuration of the terminal device and the equipment. Reference to the log information is permitted even if there is discrepancy between the operating information received from the terminal device and the operating information included in the log information. This improves user-friendliness.

In the information processing method described above, the operating information included in the log information accumulated in the server may include sensor information obtained by the server from the equipment, and the operating information received from the terminal device may include sensor information obtained by the terminal device from the equipment.

With this configuration, the operating information included in the log information accumulated in the server includes the sensor information obtained by the server from the equipment, and the operating information received from the terminal device includes the sensor information obtained by the terminal device from the equipment. Thus, it is difficult to falsify the sensor information obtained from the equipment, and falsification of the operating information received from the terminal device is prevented.

In the information processing method described above, if operating information corresponding to a time same as the predetermined time does not exist in the log information, the determining of whether the predetermined condition is satisfied may be made by deriving a plurality of pieces of operating information from the log information, interpolating operating information corresponding to the predetermined time using the derived plurality of pieces of operating information, and determining whether the received operating information matches the interpolated operating information.

With this configuration, if operating information corresponding to a time same as the predetermined time does not exist in the log information, the operating information corresponding to the predetermined time is interpolated from a plurality of pieces of operating information included in the log information. For example, the amount of the operating information stored in the equipment can be reduced to reduce the storage capacity of a memory of the equipment.

In the information processing method described above, the receiving may be receiving of the identification information, the operating information, and event information for identifying an event happened at the predetermined time in the equipment, and, if the operating information corresponding to the time same as the predetermined time does not exist in the log information, the determining of whether the predetermined condition is satisfied may be made by obtaining an operating property of the equipment corresponding to the event information, deriving a plurality pieces of operating information from the log information, and interpolating operating information corresponding to the predetermined time using the obtained operating property and the derived plurality of pieces of operating information.

With this configuration, the operating information corresponding to the predetermined time is interpolated using the operating property of the equipment corresponding to the event happened in the equipment at the predetermined time and a plurality of pieces of operating information derived from the log information. In this manner, the operating information corresponding to the predetermined time can accurately be interpolated.

In the information processing method described above, the information processing method may further include transmitting the log information to the terminal device if reference to the log information is permitted.

With this configuration, the log information is transmitted to the terminal device if reference to the log information is permitted, and the terminal device presents the log information of the equipment to the user.

In the information processing method described above, the information processing method may further include transmitting information instructing a user to manipulate the equipment to the terminal device if reference to the log information is not permitted.

With this configuration, the information instructing the user to manipulate the equipment is transmitted to the terminal device if reference to the log information is not permitted, and the user then manipulates the equipment to cause the server to obtain the latest operating information. The latest operating information thus satisfies the condition that the predetermined time is included in the predetermined standard period ending at the current time, and thus the log information can be referred to.

A server according to another embodiment of the disclosure includes a receiver configured to receive identification information for identifying the equipment and operating information of the equipment corresponding to a predetermined time, the identification information and the operating information being transmitted from a terminal device connected to the server via a network, a determining unit configured to determine whether the received operating information satisfies a predetermined condition, and a reference controller configured to permit the terminal device, if it is determined that the received operating information satisfies the predetermined condition, to refer to the log information of the equipment accumulated in the server, the log information corresponding to the identification information corresponding to a time before the predetermined time, and not permit the terminal device, if it is determined that the received operating information does not satisfy the predetermined condition, to refer to the log information of the equipment accumulated in the server. The predetermined condition is that the predetermined time is included in a predetermined standard period ending at a current time and the received operating information matches operating information included in the log information of the equipment corresponding to a time in the standard period and accumulated in the server.

According to the configuration, reference to the log information is permitted if the operating information received from the terminal device matches the operating information included in the log information of the equipment corresponding to a time in the standard period and accumulated in the server. This reduces a workload of managing data used for controlling permission of reference. Meanwhile, reference to the log information is permitted if the predetermined time corresponding to the operating information received from the terminal device is included in the predetermined standard period ending at the current time, so that reference to the log information is not permitted after the predetermined standard period has passed. This prevents leakage of log information.

A non-transitory computer-readable recording medium records an information processing program for controlling reference to accumulated log information of an equipment, the information processing program causing a computer to execute: receiving identification information for identifying the equipment and operating information of the equipment corresponding to a predetermined time, the identification information and the operating information being transmitted from a terminal device connected to the server via a network, determining whether the received operating information satisfies a predetermined condition, permitting the terminal device, if it is determined that the received operating information satisfies the predetermined condition, to refer to the log information of the equipment accumulated in the server, the log information corresponding to the identification information corresponding to a time before the predetermined time, and not permitting the terminal device, if it is determined that the received operating information does not satisfy the predetermined condition, to refer to the log information of the equipment accumulated in the server. The predetermined condition is that the predetermined time is included in a predetermined standard period ending at a current time and the received operating information matches operating information included in the log information of the equipment corresponding to a time in the standard period and accumulated in the server.

According to the configuration, reference to the log information is permitted if the operating information received from the terminal device matches the operating information included in the log information of the equipment corresponding to a time in the standard period and accumulated in the server. This reduces a workload of managing data used for controlling permission of reference. Meanwhile, reference to the log information is permitted if the predetermined time corresponding to the operating information received from the terminal device is included in the predetermined standard period ending at the current time, so that reference to the log information is not permitted after the predetermined standard period has passed. This prevents leakage of log information.

Embodiments of the disclosure will be described with reference to the attached drawings. The embodiment described below is a specific example of the disclosure. Values, shapes, components, steps, and orders of the steps, for example, described in the embodiment below are illustrated by means of illustration and not by means of limiting the scope of the disclosure. Among the components of the embodiment, the component not included in an independent claim describing the broadest concept is described as a component which is arbitrarily employed.

### Embodiments

A data reference method will be described below as an example embodiment of the disclosure with reference to the drawings.

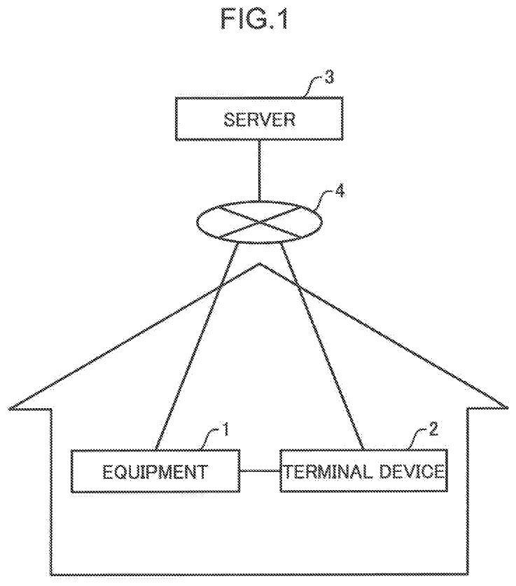

FIG. 1 illustrates an example configuration of a data reference system according to an embodiment of the disclosure. The data reference system illustrated in FIG. 1 includes an equipment 1, a terminal device 2, and a server 3.

The equipment 1 is, for example, a consumer electronics equipment such as an air conditioner. The equipment 1 and the terminal device 2 are interconnected wirelessly or by wire via, for example, a wireless local area network (LAN), to communicate with each other. The equipment 1 is connected to the server 3 via a network 4 wirelessly or by wire to communicate with each other. The network 4 is, for example, the internet, which is a public line.

The terminal device 2 is, for example, a smart phone, a tablet computer, or a personal computer. The terminal device 2 checks operating information including information indicating sensor information and a run condition of the equipment 1. The terminal device 2 is connected to the server 3 via the network 4 to communicate with each other. The terminal device 2 obtains log information of the equipment 1 stored in the server 3 from the server 3 and displays the obtained log information on a screen.

The server 3 is, for example, a web server. The server 3 is connected to the equipment 1 via the network 4 to communicate with each other. The server 3 monitors the operating information of the equipment 1 and gathers past operating information of the equipment 1 as log information. The server 3 is connected to the terminal device 2 via the network 4 to communicate with each other. The network 4 is, for example, a public line. The server 3 is also connected to other consumer electronics equipment or coupling devices not shown in FIG. 1. The server 3 can thus communicate with a plurality of pieces of equipment and a plurality of terminal devices.

A concept of using the embodiment will now be described. The equipment 1 is a consumer electronics equipment provided in a house of a typical user. For example, when the user of the equipment 1 finds an unusual operation of the equipment 1, the user calls a call center of a manufacturer of the equipment 1. On receiving the call, the manufacturer dispatches a mechanic to the user's house. The mechanic brings the terminal device 2 and visits the user's house. The terminal device 2 obtains log information of the equipment 1 from the server 3 and presents the obtained log information to the mechanic. The mechanic checks the log information of the equipment 1 presented on the terminal device 2 to identify a malfunctioning part of the equipment 1, and properly repairs the equipment 1.

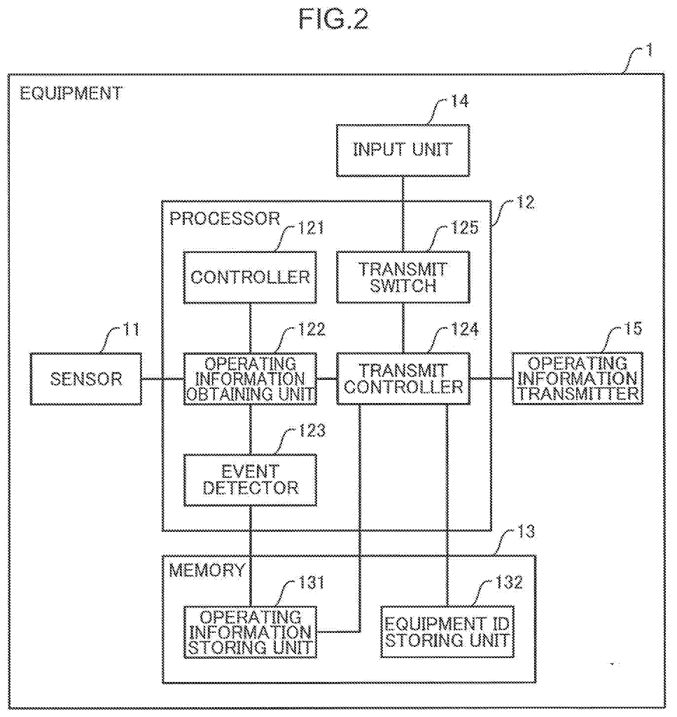

FIG. 2 illustrates an example configuration of an equipment according to the embodiment of the disclosure.

The equipment 1 illustrated in FIG. 2 includes a sensor 11, a processor 12, a memory 13, an input unit 14, and an operating information transmitter 15. The processor 12 is, for example, a central processing unit (CPU) including a controller 121, an operating information obtaining unit 122, an event detector 123, a transmit controller 124, and a transmit switch 125. The memory 13 is, for example, a semiconductor memory including an operating information storing unit 131 and an equipment identification (ID) storing unit 132.

The sensor 11 measures an environmental state around and/or inside the equipment 1. The sensor 11 measures, for example, a temperature around or inside the equipment 1.

The controller 121 controls running of the equipment 1. For example, when the equipment 1 is an air conditioner, the controller 121 controls an operation of the air conditioner according to a run mode and a set temperature.

The operating information obtaining unit 122 obtains operating information. The operating information includes sensor information of the equipment 1 obtained by the sensor 11 and run condition information output from the controller 121. The operating information obtaining unit 122 regularly obtains the sensor information of the equipment 1 from the sensor 11 and the run condition information from the controller 121. For example, when the equipment 1 is an air conditioner, the run condition information is a compressor frequency. The run condition information is, for example, a controlling value output from the controller 121 to each part of the equipment 1.

The event detector 123 detects an event based on the sensor information and the run condition information obtained by the operating information obtaining unit 122. The event is related to a change in the condition of the equipment 1, for example, an error happening in the equipment 1, a start of running the equipment 1, or a stop of running the equipment 1.

The operating information storing unit 131 stores the operating information corresponding to the time at which an event has been detected with the operating information associated with time information indicating the time at which the event has been detected. The event detector 123 stores the operating information corresponding to the time at which the event has been detected with the operating information associated with the time information indicating the time at which the event has been detected and event information for identifying the event that has happened.

The input unit 14 is, for example, a button switch or a touch panel, which is a user interface for switching the destination, to which the operating information related to the equipment 1 is transmitted, from the server 3 to the terminal device 2.

The transmit switch 125 switches the destination, to which the operating information related to the equipment 1 is transmitted, from the server 3 to the terminal device 2 based on an input manipulation given from the input unit 14.

The equipment ID storing unit 132 stores an identifier (equipment ID) unique to the equipment 1 to identify the equipment 1.

The transmit controller 124 controls the operating information transmitter 15. When sending the operating information obtained by the operating information obtaining unit 122 to the server 3, the transmit controller 124 reads the identifier stored in the equipment ID storing unit 132. The transmit controller 124 outputs to the operating information transmitter 15 the operating information obtained by the operating information obtaining unit 122 and the identifier read from the equipment ID storing unit 132.

A time interval at which the transmit controller 124 transmits the operating information to the server 3 may be same as or different from a time interval at which the operating information obtaining unit 122 obtains the operating information. The event detector 123 detects happening of an event based on the operating information obtained by the operating information obtaining unit 122. It is preferable that the time interval at which the operating information obtaining unit 122 obtains the operating information is shorter than the time interval at which the transmit controller 124 transmits the operating information to the server 3. The time interval at which the operating information obtaining unit 122 obtains the operating information is, for example, one minute. The time interval at which the transmit controller 124 transmits the operating information to the server 3 is, for example, five minutes.

When the transmit switch 125 switches the destination from the server 3 to the terminal device 2, the transmit controller 124 reads the operating information, the time information, and the event information stored in the operating information storing unit 131 and the identifier stored in the equipment ID storing unit 132. The transmit controller 124 outputs to the operating information transmitter 15 the operating information, the time information, and the event information read from the operating information storing unit 131 and the identifier read from the equipment ID storing unit 132.

The operating information transmitter 15 regularly transmits to the server 3 the operating information obtained by the operating information obtaining unit 122 and the identifier read from the equipment ID storing unit 132. The operating information transmitter 15 transmits to the terminal device 2 the operating information, the time information, and the event information read from the operating information storing unit 131 and the identifier read from the equipment ID storing unit 132.

After the operating information transmitter 15 has transmitted the operating information, the time information, the event information, and the identifier to the terminal device 2, the transmit switch 125 switches the destination, to which the operating information related to the equipment 1 is transmitted, from the terminal device 2 to the server 3.

The memory 13 of the equipment 1 has a smaller capacity than the server 3. Since the operating information storing unit 131 can hardly store every pieces of regularly obtained operating information, the operating information storing unit 131 only stores the operating information corresponding to a timing at which the event has happened. Since the operating information storing unit 131 can hardly store all pieces of operating information corresponding to a timing at which the event has happened, the latest three pieces of operating information are stored in the operating information storing unit 131. The operating information transmitter 15 transmits the regularly obtained operating information to the server 3. The server 3 stores the operating information regularly transmitted from the equipment 1 as log information. If reference to the log information of the equipment 1 accumulated in the server 3 is permitted, the terminal device 2 obtains the log information from the server 3 and presents the log information to the user. The user checks the log information, which is a piece of past operating information of the equipment 1, and uses the log information, for example, for failure diagnosis of the equipment 1. In the embodiment, the user is a person who uses the terminal device 2. For example, the user is a mechanic who repairs the equipment 1. In the embodiment, the user may be a person who uses the equipment 1. In this case, the user of the equipment 1 and the user of the terminal device 2 may be a same person.

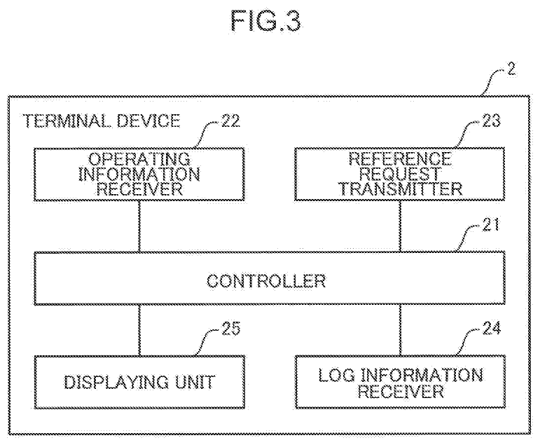

FIG. 3 illustrates an example configuration of the terminal device according to the embodiment of the disclosure.

The terminal device 2 illustrated in FIG. 3 includes a controller 21, an operating information receiver 22, a reference request transmitter 23, a log information receiver 24, and a displaying unit 25.

The controller 21 controls parts of the terminal device 2.

The operating information receiver 22 communicates with the equipment 1 to receive the operating information, the time information, the event information, and the identifier of the equipment 1 that are transmitted by the equipment 1.

The reference request transmitter 23 communicates with the server 3 via the network 4 to transmit reference request information to the server 3 to request reference to the log information of the equipment 1 stored in the server 3. The reference request information includes the operating information, the time information, the event information, and the identifier of the equipment 1 that are received by the operating information receiver 22.

The log information receiver 24 communicates with the server 3 via the network 4 to receive the log information of the equipment 1 transmitted by the server 3.

The displaying unit 25 displays the operating information, the time information, and the event information of the equipment 1 that are received by the operating information receiver 22. The displaying unit 25 displays the log information of the equipment 1 received by the log information receiver 24.

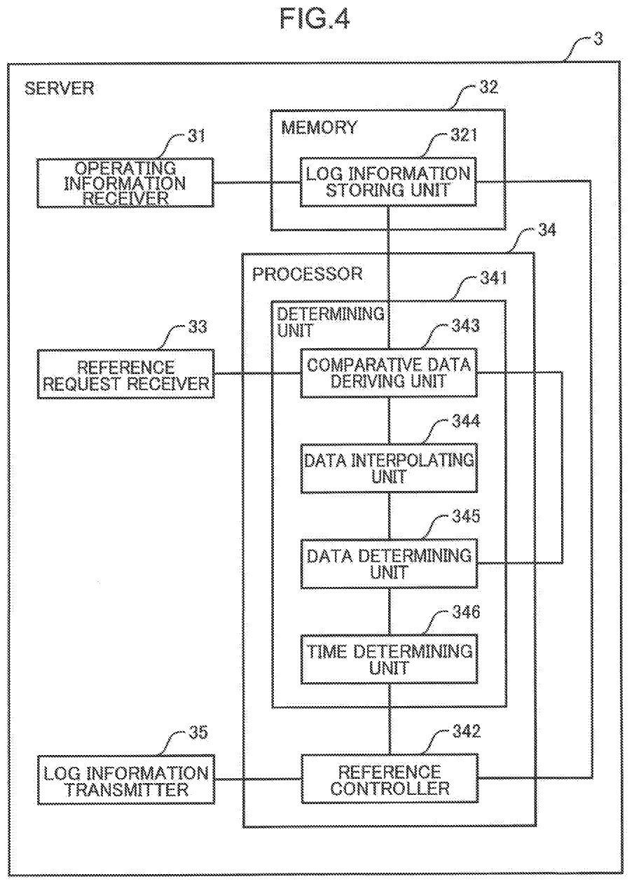

FIG. 4 illustrates an example configuration of the server according to the embodiment of the disclosure.

The server 3 illustrated in FIG. 4 includes an operating information receiver 31, a memory 32, a reference request receiver 33, a processor 34, and a log information transmitter 35.

The memory 32 is, for example, a semiconductor memory or a hard disk drive that includes a log information storing unit 321.

The processor 34 is, for example, a CPU including a determining unit 341 and a reference controller 342.

The operating information receiver 31 communicates with the equipment 1 via the network 4 to receive the operating information of the equipment 1 and the identifier of the equipment 1 that are transmitted by the equipment 1. The operating information includes sensor information and run condition information. The operating information receiver 31 stores in the log information storing unit 321 the received operating information, the received identifier, and a received time of the operating information.

The log information storing unit 321 accumulates the operating information of the equipment 1, the identifier of the equipment 1 received by the operating information receiver 31, and the received time at which the operating information receiver 31 has received the operating information and the identifier, with the operating information, the identifier, and the received time associated with each other. The operating information included in the log information accumulated in the server 3 includes the sensor information obtained by the server 3 from the equipment 1.

The reference request receiver 33 communicates with the terminal device 2 via the network 4 to receive the reference request information for requesting reference to the log information of the equipment 1 transmitted by the terminal device 2. The reference request information includes the operating information that corresponds to a timing at which the event has happened and is received from the equipment 1 by the terminal device 2, the time information of the happened event, the event information indicating the content of the happened event, and the identifier of the equipment 1. That is, the reference request receiver 33 receives the identifier (identification information) for identifying the equipment 1, and the operating information of the equipment 1 corresponding to the predetermined time, the identifier and the operating information being transmitted from the terminal device 2 connected to the server 3 via the network 4. The operating information received from the terminal device 2 includes the sensor information obtained by the terminal device 2 from the equipment 1.

The determining unit 341 determines whether the operating information included in the reference request information received by the reference request receiver 33 satisfies a predetermined condition. The predetermined condition is that the predetermined time is included in a predetermined standard period ending at the current time and the received operating information matches the operating information included in the log information of the equipment 1 corresponding to a time in the standard period and accumulated in the server 3.

If the operating information corresponding to a time same as the predetermined time does not exist in the log information, the determining unit 341 derives a plurality of pieces of operating information from the log information, and interpolates the operating information corresponding to the predetermined time using the derived pieces of operating information to determine whether the received operating information matches the interpolated operating information.

The determining unit 341 includes a comparative data deriving unit 343, a data interpolating unit 344, a data determining unit 345, and a time determining unit 346.

Based on the identifier and the time information of the equipment 1 included in the reference request information received by the reference request receiver 33, the comparative data deriving unit 343 derives comparative operating information included in the log information of the equipment 1 corresponding to a time in the standard period and accumulated in the log information storing unit 321. The comparative data deriving unit 343 derives from the log information of the equipment 1 the comparative operating information corresponding to the predetermined time same as the time information included in the reference request information. If the operating information corresponding to the predetermined time same as the time information included in the reference request information does not exist in the log information, the comparative data deriving unit 343 derives a plurality of pieces of operating information from the log information.

If the operating information corresponding to the predetermined time same as the time information included in the reference request information does not exist in the log information, the data interpolating unit 344 interpolates comparative operating information corresponding to the predetermined time using a plurality pieces of operating information derived by the comparative data deriving unit 343.

If the time information of the equipment 1 included in the reference request information received by the reference request receiver 33 does not match the time information included in the log information of the equipment 1 accumulated in the log information storing unit 321, the data interpolating unit 344 interpolates comparative operating information corresponding to the predetermined time same as the time information of the equipment 1 included in the reference request information using a plurality of pieces of operating information of the equipment 1 derived by the comparative data deriving unit 343. Then, the data interpolating unit 344 generates the comparative operating information corresponding to a time same as the time information of the equipment 1 included in the reference request information received by the reference request receiver 33 from the log information of the equipment 1 accumulated in the log information storing unit 321.

The data determining unit 345 determines whether the operating information received by the reference request receiver 33 matches the operating information included in the log information of the equipment 1 corresponding to a time in the standard period and accumulated in the server 3.

That is, if the operating information corresponding to the predetermined time same as the time information included in the reference request information exists in the log information, the data determining unit 345 determines whether the operating information corresponding to the predetermined time and included in the reference request information matches the comparative operating information corresponding to the predetermined time and derived by the comparative data deriving unit 343. If the operating information corresponding to the predetermined time same as the time information included in the reference request information does not exist in the log information, the data determining unit 345 determines whether the operating information corresponding to the predetermined time and included in the reference request information matches the comparative operating information corresponding to the predetermined time and interpolated by the data interpolating unit 344.

The data determining unit 345 determines whether the operating information of the equipment 1 included in the reference request information received by the reference request receiver 33 matches the comparative operating information derived from the log information by the comparative data deriving unit 343, the comparative operating information corresponding to a time same as the time information corresponding to the operating information. The data determining unit 345 determines whether the operating information of the equipment 1 included in the reference request information received by the reference request receiver 33 matches the comparative operating information generated by the data interpolating unit 344, the comparative operating information corresponding to a time same as the time information corresponding to the operating information.

The time determining unit 346 determines whether the predetermined time is included in the predetermined standard period ending at the current time. That is, the time determining unit 346 determines whether a difference between the latest piece of time information in the time information of the equipment 1 included in the reference request information received by the reference request receiver 33 and the current time is within a predetermined time.

If the determining unit 341 determines that the operating information received by the reference request receiver 33 satisfies the predetermined condition, the reference controller 342 permits the terminal device 2 to refer to the log information, accumulated in the server 3, of the equipment 1 corresponding to the identifier (identification information) corresponding to a time before the predetermined time. If the determining unit 341 determines that the operating information received by the reference request receiver 33 does not satisfy the predetermined condition, the reference controller 342 does not permit the terminal device 2 to refer to the log information of the equipment 1 accumulated in the server 3.

If the data determining unit 345 determines that the operating information received by the reference request receiver 33 matches the comparative operating information included in the log information of the equipment 1 corresponding to a time in the standard period and accumulated in the server 3, and if the time determining unit 346 determines that the predetermined time in the time information received by the reference request receiver 33 is included in the predetermined standard period ending at the current time, the reference controller 342 derives log information related to the equipment 1 and accumulated in the log information storing unit 321.

The log information transmitter 35 communicates with the terminal device 2 via the network 4 to transmit the log information related to the equipment 1 and derived by the reference controller 342 to the terminal device 2. If reference to the log information is permitted, the log information transmitter 35 transmits the log information to the terminal device 2.

If reference to the log information is not permitted, the log information transmitter 35 transmits to the terminal device 2 information instructing the user to manipulate the equipment 1. If the terminal device 2 is not permitted to refer to the log information, the time information corresponding to the operating information stored in the terminal device 2 may not be included in the predetermined standard period ending at the current time. The user then manipulates to start running the equipment 1, and an event of a start of running happens in the equipment 1. The operating information and the time information corresponding to a timing at which the latest event has happened are stored in the equipment 1, and the operating information and the time information stored in the equipment 1 are transmitted to the terminal device 2. Now, the time information corresponding to the operating information stored in the terminal device 2 is included in the predetermined standard period ending at the current time, and the terminal device 2 is permitted to refer to the log information.

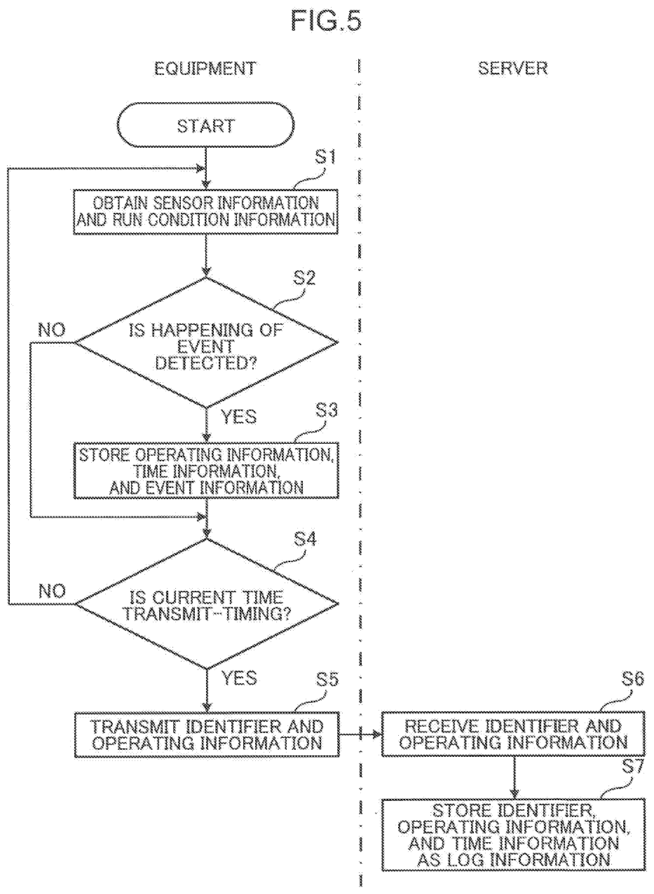

Log information accumulation processing performed among the equipment 1 and the server 3 will now be described using FIG. 5.

FIG. 5 is a flowchart for explaining the log information accumulation processing according to the embodiment of the disclosure. In the log information accumulation processing, the operating information of the equipment 1 is stored in the equipment 1, the operating information stored in the equipment 1 is gathered by the server 3, and the gathered operating information is accumulated in the server 3 as log information.

First, in step S1, the operating information obtaining unit 122 of the equipment 1 obtains sensor information of the equipment 1 from the sensor 11 and run condition information of the equipment 1 from the controller 121. The operating information obtaining unit 122 may obtain only the sensor information of the equipment 1 from the sensor 11 or obtain only the run condition information of the equipment 1 from the controller 121. The operating information obtaining unit 122 regularly obtains the sensor information and the run condition information.

Next, in step S2, the event detector 123 determines whether happening of an event is detected based on the sensor information and the run condition information obtained by the operating information obtaining unit 122. The event detector 123 may detect happening of an event by comparing at least either of the sensor information and the run condition information with a predetermined threshold value. The event detector 123 may detect happening of an event using at least either of the sensor information and the run condition information in a predetermined function or an arithmetic expression.

For example, when the sensor information is a room pipe temperature of an air conditioner, the event detector 123 detects that an error has happened if the room pipe temperature is higher than an upper limit or the room pipe temperature is lower than a lower limit.

If it is determined that no happening of an event is detected (NO in step S2), the step proceeds to step S4.

If happening of an event is detected (YES in step S2), in step S3, the event detector 123 stores in the operating information storing unit 131 the operating information including sensor information and run condition information corresponding to the timing at which the event has been detected, the time information indicating the time at which the event has been detected, and the event information indicating the content of the detected event with the operating information, the time information, and the event information associated with each other.

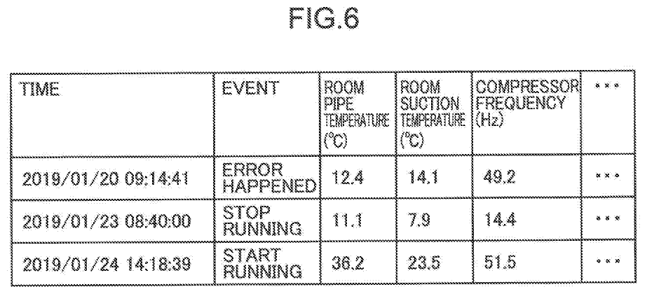

FIG. 6 illustrates example table data stored in the operating information storing unit of the equipment according to the embodiment. The operating information storing unit 131 stores table data in which the operating information, the time information, and the event information are associated with each other.

The table data illustrated in FIG. 6 includes the time information indicating the time at which happening of an event has been detected, the event information indicating the content of the detected event, and the operating information including the sensor information and the run condition information corresponding to the timing at which the event has been detected. The sensor information is, for example, a room pipe temperature and a room suction temperature. The run condition information is, for example, a compressor frequency. The operating information storing unit 131 stores, for example, time information of “2019/01/24 14:18:39”, event information of “start running”, a room pipe temperature of “36.2° C.”, a room suction temperature of “23.5° C.”, and a compressor frequency of “51.5 Hz” with the time information, the event information, the room pipe temperature, the room suction temperature, and the compressor frequency associated with each other.

The operating information is not limited to the room pipe temperature, the room suction temperature, and the compressor frequency illustrated in FIG. 6. The event information is not limited to happening of an error, a start of running, and a stop of running illustrated in FIG. 6.

Referring back to FIG. 5, in step S4, the transmit controller 124 determines whether the current time is a transmit-timing to transmit the operating information to the server 3. When operating information is to be transmitted every five minutes, for example, the transmit controller 124 may determine whether five minutes has passed at the current time since transmission of the last operating information. For example, when times to transmit operating information is previously determined as 18:00, 18:05, and 18:10, the transmit controller 124 may determine whether the current time is a previously determined transmit-time.

If it is determined that the current time is not a transmit-timing, (NO in step S4), the step returns to step S1.

Meanwhile, if it is determined that the current time is a transmit-timing (YES in step S4), the operating information transmitter 15 transmits to the server 3 in step S5 the identifier of the equipment 1 stored in the equipment ID storing unit 132, and the operating information of the equipment 1 including the sensor information and the run condition information obtained by the operating information obtaining unit 122.

In step S6, the operating information receiver 31 of the server 3 receives the identifier and the operating information of the equipment 1 transmitted by the operating information transmitter 15 of the equipment 1.

In step S7, the operating information receiver 31 stores in the log information storing unit 321 the received identifier of the equipment 1, the received operating information, and time information indicating the time at which the operating information has been received as log information.

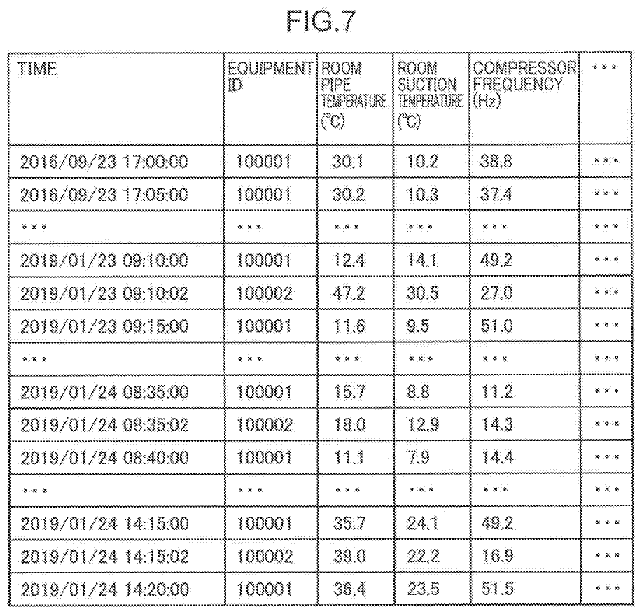

FIG. 7 illustrates example table data stored in a log information storing unit of the server according to the embodiment. The log information storing unit 321 stores table data in which the time information indicating the time at which the operating information has been received, the identifier of the equipment 1, and the operating information are associated with each other.

The table data illustrated in FIG. 7 includes time information indicating the time at which the operating information has been received, the identifier of the equipment 1 (equipment ID), and operating information of the equipment 1 including the sensor information and the run condition information. The sensor information is, for example, a room pipe temperature and a room suction temperature. The run condition information is, for example, a compressor frequency. The log information storing unit 321 stores, for example, time information of “2019/01/24 14:20:00”, an identifier (equipment ID) of “100001”, a room pipe temperature of “36.4° C.”, a room suction temperature of “23.5° C.”, and a compressor frequency of “51.5 Hz” with the time information, the identifier, the room pipe temperature, the room suction temperature, and the compressor frequency associated with each other.

As illustrated in FIG. 7, the log information storing unit 321 stores a single piece of table data in which the time information, the identifier, and the operating information are accumulated in an order of timing of receiving the operating information. However, the disclosure is not limited to this configuration. The log information storing unit 321 may store a plurality of pieces of table data to accumulate time information and operating information for each identifier.

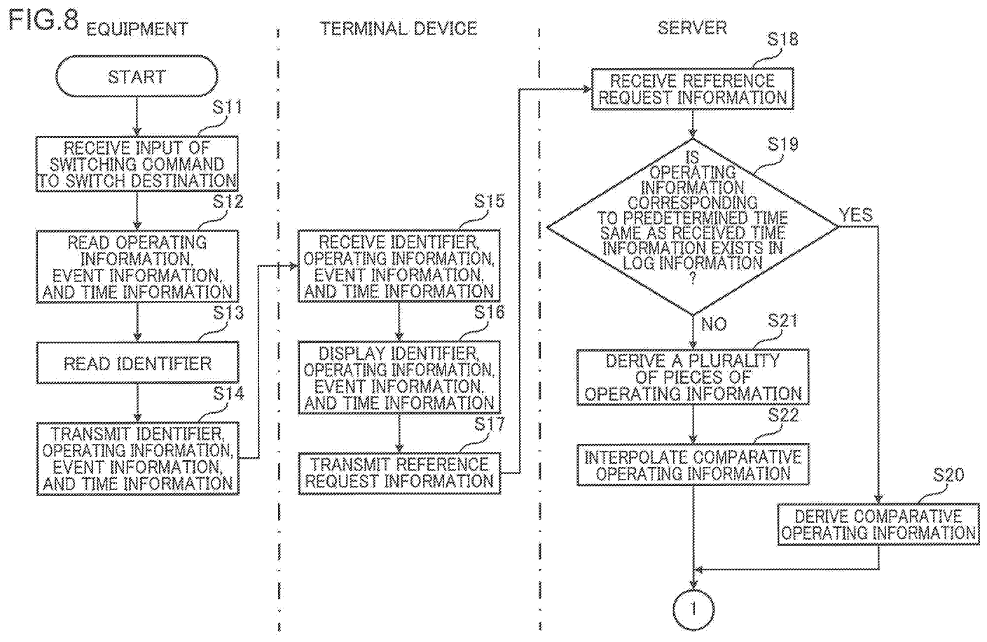

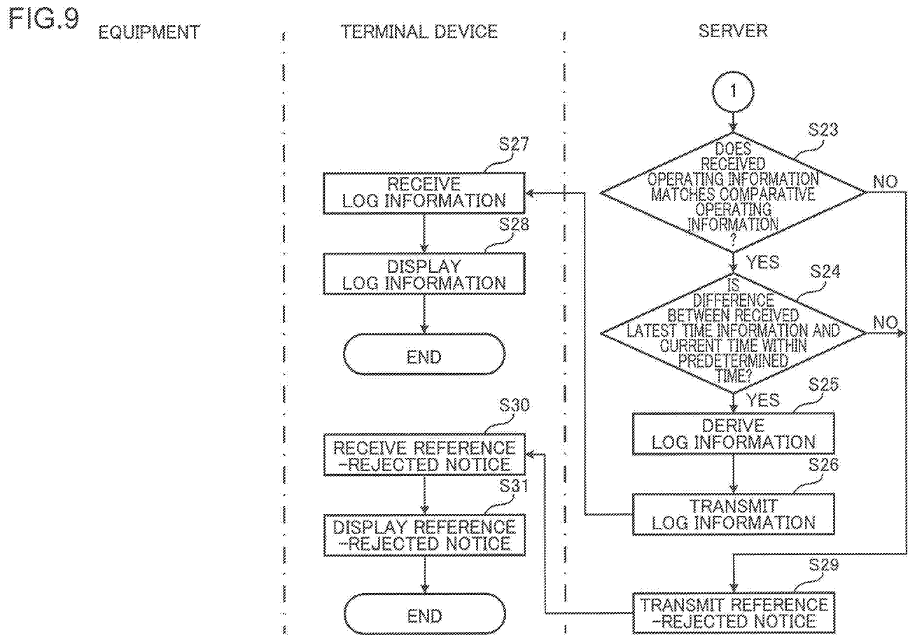

Now, reference control processing performed among the equipment 1, the terminal device 2, and the server 3 will be described with reference to FIGS. 8 and 9.

FIG. 8 is a first flowchart for explaining reference control processing performed by a data reference system according to the embodiment of the disclosure. FIG. 9 is a second flowchart for explaining the reference control processing performed by the data reference system according to the embodiment of the disclosure.

In step S11, the input unit 14 of the equipment 1 receives an input of a switching command given by a user to switch the destination of the operating information of the equipment 1 from the server 3 to the terminal device 2. The user is a person who wants to refer to the log information of the equipment 1 accumulated in the server 3. For example, the input unit 14 is a button switch. By the user pushing the button switch, the transmit switch 125 switches the destination of the operating information from the server 3 to the terminal device 2.

In the embodiment, the transmit switch 125 switches the destination of the operating information from the server 3 to the terminal device 2 by the user pushing the button switch. However, the disclosure is not limited to this configuration. The terminal device 2 may receive an input, given by the user, of a switching command to switch the destination of the operating information of the equipment 1 from the server 3 to the terminal device 2. In this case, the terminal device 2 transmits the switching command to the equipment 1. The equipment 1 receives the switching command transmitted by the terminal device 2. On receiving the switching command, the transmit switch 125 switches the destination of the operating information from the server 3 to the terminal device 2.

In step S12, the transmit controller 124 reads the operating information, the event information, and the time information of the equipment 1 stored in the operating information storing unit 131. In the embodiment, when the operating information storing unit 131 stores data of a plurality of records, the transmit controller 124 reads data of all the records. For example, as illustrated in FIG. 6, when the operating information storing unit 131 stores data of three records, the transmit controller 124 reads data of the three records.

The transmit controller 124 may read data of some records among a plurality of records. For example, the transmit controller 124 may read only data of the latest record among a plurality of records or sequentially read the latest three records among a plurality of records.

In step S13, the transmit controller 124 reads the identifier of the equipment 1 stored in the equipment ID storing unit 132. The transmit controller 124 outputs the identifier, the operating information, the event information, and the time information to the operating information transmitter 15.

In step S14, the operating information transmitter 15 transmits the identifier, the operating information, the event information, and the time information of the equipment 1 to the terminal device 2.

In step S15, the operating information receiver 22 of the terminal device 2 receives the identifier, the operating information, the event information, and the time information of the equipment 1 transmitted by the operating information transmitter 15 of the equipment 1.

In step S16, the displaying unit 25 presents the identifier, the operating information, the event information, and the time information of the equipment 1 received by the operating information receiver 22.

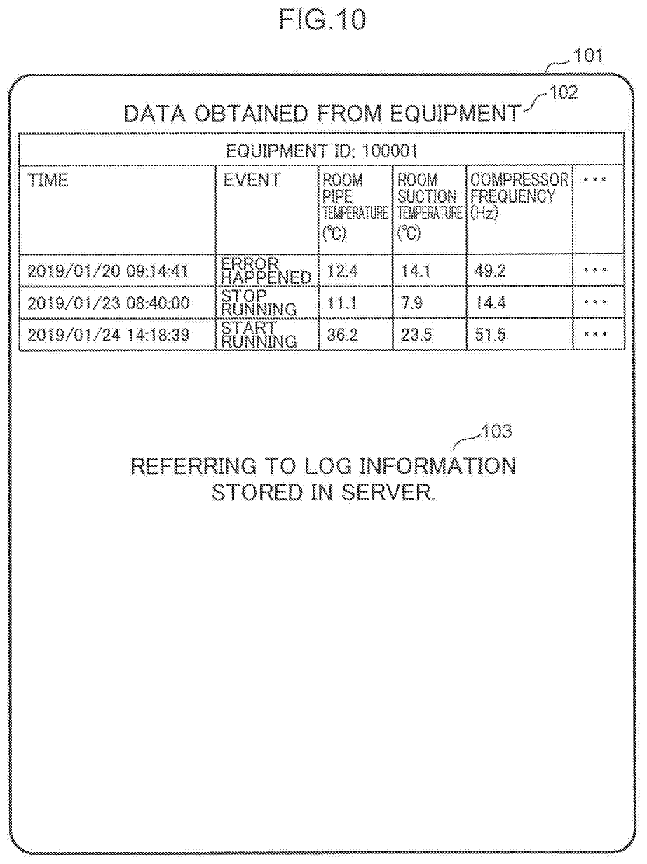

FIG. 10 illustrates an example data display screen displayed on the displaying unit of the terminal device of the embodiment. The displaying unit 25 presents a data display screen 101 that presents the identifier, the operating information, the event information, and the time information received from the equipment 1 to the user.

The data display screen 101 illustrated in FIG. 10 is a screen that displays data related to the equipment 1 and received by the operating information receiver 22. An image 102 showing the identifier, the operating information, the event information, and the time information of the equipment 1 received by the operating information receiver 22 is displayed in an upper part of the data display screen 101. A message 103 telling that the log information of the equipment 1 stored in the server 3 is referred to is displayed in a lower part of the data display screen 101.

Referring back to FIG. 8, in step S17, the reference request transmitter 23 transmits reference request information to the server 3 to request reference to the log information of the equipment 1. The reference request information includes the identifier, the operating information, the event information, and the time information of the equipment 1 received by the operating information receiver 22.

In step S18, the reference request receiver 33 of the server 3 receives the reference request information transmitted by the reference request transmitter 23 of the terminal device 2.

In step S19, the comparative data deriving unit 343 determines whether operating information corresponding to a predetermined time same as the time information included in the received reference request information exists in the log information corresponding to the identifier of the equipment 1 included in the reference request information.

If it is determined that the operating information corresponding to the predetermined time same as the received time information exists in the log information (YES in step S19), the comparative data deriving unit 343 derives in step S20 comparative operating information corresponding to the predetermined time same as the time information included in the reference request information from the log information corresponding to the identifier of the equipment 1 included in the reference request information received by the reference request receiver 33.

Meanwhile, if it is determined that the operating information corresponding to the predetermined time same as the received time information does not exist in the log information (NO in step S19), the comparative data deriving unit 343 derives in step S21 a plurality of pieces of operating information from the log information corresponding to the identifier of the equipment 1 included in the reference request information. In this process, the comparative data deriving unit 343 derives a plurality of pieces of operating information included in a predetermined period before and after the predetermined time indicated by the time information included in the reference request information. The comparative data deriving unit 343 may derive a plurality of pieces of operating information in an order of closeness to the predetermined time indicated by the time information included in the reference request information.

In step S22, the data interpolating unit 344 interpolates comparative operating information corresponding to the predetermined time same as the time information of the equipment 1 included in the reference request information using a plurality of pieces of operating information of the equipment 1 derived by the comparative data deriving unit 343.

Interpolation processing performed by the data interpolating unit 344 will be described.

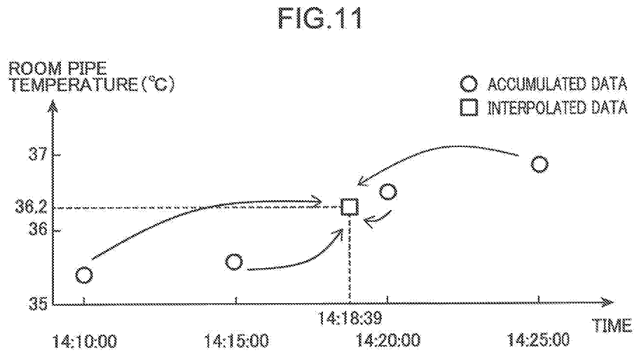

FIG. 11 is a schematic figure for explaining the interpolation processing performed by the data interpolating unit of the embodiment. In FIG. 11, the predetermined time indicated by the time information included in the reference request information is “2019/01/24 14:18:39”. The equipment 1 is an air conditioner and the operating information is a room pipe temperature. In this case, the comparative data deriving unit 343 derives, for example, four pieces of operating information, which are a room pipe temperature of “35.4° C.” corresponding to a time of “2019/01/24 14:10:00”, a room pipe temperature of “35.7° C.” corresponding to a time of “2019/01/24 14:15:00”, a room pipe temperature of “36.4° C.” corresponding to a time of “2019/01/24 14:20:00”, and a room pipe temperature of “36.9° C.” corresponding to a time of “2019/01/24 14:25:00”. The data interpolating unit 344 interpolates a room pipe temperature of “36.2° C.” at a time “2019/01/24 14:18:39” using the four pieces of operating information derived by the comparative data deriving unit 343.

The data interpolating unit 344 may interpolate comparative operating information using the event information included in the reference request information received by the reference request receiver 33. The reference request information includes the event information for identifying an event happened in the equipment 1 at the predetermined time. If the operating information corresponding to a time same as the predetermined time does not exist in the log information, the data interpolating unit 344 may obtain an operating property of the equipment 1 corresponding to the event information. The operating property of the equipment 1 corresponding to the event information is previously stored in the memory 32. The data interpolating unit 344 may derive a plurality of pieces of operating information from the log information and interpolate comparative operating information corresponding to the predetermined time using the obtained operating property and a plurality of derived operating information.

For example, if the reference request information includes the event information of “start running”, the data interpolating unit 344 may obtain the operating property at the start of running of the equipment 1. The data interpolating unit 344 may interpolate comparative operating information corresponding to the predetermined time of “2019/01/24 14:18:39” using the operating information corresponding to the time “2019/01/24 14:15:00” and the operating information corresponding to the time “2019/01/24 14:20:00” included in the log information, and the operating property corresponding to the start of running the equipment 1. By previously recognizing the operating property of the equipment 1 corresponding to the happened event as described above, a change in operating information before and after the happening of the event can easily be estimated. This improves accuracy of interpolating the comparative operating information.

In step S23, the data determining unit 345 determines whether the operating information of the equipment 1 corresponding to the predetermined time and included in the reference request information received by the reference request receiver 33 matches the comparative operating information corresponding to the predetermined time. The comparative operating information is comparative operating information corresponding to the predetermined time and derived by the comparative data deriving unit 343 or comparative operating information corresponding to the predetermined time and interpolated by the data interpolating unit 344.

For example, the data determining unit 345 determines whether a room pipe temperature of “36.2° C.”, a room suction temperature of “23.5° C.”, and a compressor frequency of “51.5 Hz”, which are pieces of operating information corresponding to the time “2019/01/24 14:18:39” included in the reference request information shown in FIG. 6, respectively match a room pipe temperature of “36.2° C.”, a room suction temperature of “23.5° C.”, and a compressor frequency of “51.5 Hz”, which are pieces of comparative operating information corresponding to the time “2019/01/24 14:18:39” and interpolated by the data interpolating unit 344.

Determining of the matching of information needs not be made by determining whether the operating information included in the reference request information completely matches the comparative operating information. For example, if a difference between the operating information included in the reference request information and the comparative operating information is no greater than a threshold value, the data determining unit 345 may determine that the operating information included in the reference request information matches the comparative operating information. If a plurality of pieces of operating information is associated with a single piece of time information, the data determining unit 345 may determine whether all pieces of operating information each matches a corresponding piece of comparative operating information or determine whether some pieces of operating information among the plurality of pieces of operating information each matches a corresponding piece of comparative operating information. If a plurality of pieces of operating information is associated with a single piece of time information, the data determining unit 345 may determine that all pieces of operating information included in the reference request information each matches a corresponding piece of comparative operating information if a sum of a difference between all pieces of operating information and a corresponding piece of comparative operating information is no greater than a threshold value.

As illustrated in FIG. 6, when the reference request information includes a plurality of pieces of time information and a plurality of pieces of operating information each associated with a corresponding piece of time information, the data determining unit 345 may determine whether the operating information included in the reference request information entirely matches the comparative operating information.

If it is determined that the operating information included in the reference request information matches the comparative operating information (YES in step S23), the time determining unit 346 determines in step S24 whether a difference between the latest time information included in the reference request information received by the reference request receiver 33 and the current time is within a predetermined time.

If it is determined that the difference between the latest time information included in the reference request information and the current time is within the predetermined time (YES in step S24), the reference controller 342 derives in step S25 the log information of the equipment 1 accumulated in the log information storing unit 321.

For example, when the current time is “2019/01/24 14:22:42” and the latest time information included in the reference request information is “2019/01/24 14:18:39”, the time determining unit 346 determines whether the difference between the latest time information included in the reference request information and the current time is within the predetermined time. If the difference “00:04:03” is within the predetermined time, reference is permitted. In this case, if the predetermined time is five minutes, the time determining unit 346 determines that the difference between the latest time information included in the reference request information and the current time is within the predetermined time.

In step S26, the log information transmitter 35 transmits the log information of the equipment 1 derived by the reference controller 342 to the terminal device 2.

In step S27, the log information receiver 24 of the terminal device 2 receives the log information of the equipment 1 transmitted by the log information transmitter 35 of the server 3.

In step S28, the displaying unit 25 displays the log information of the equipment 1 received by the log information receiver 24.

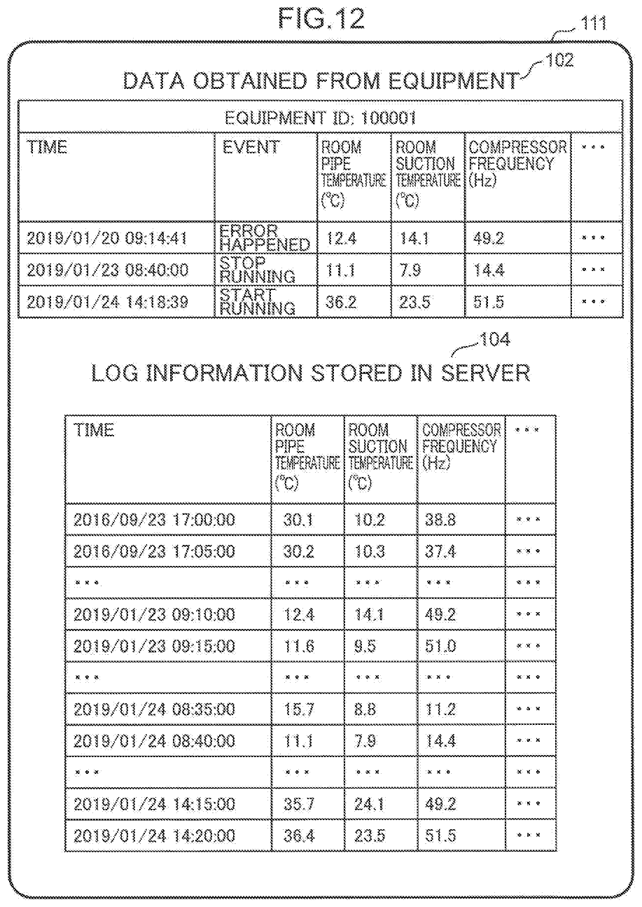

FIG. 12 illustrates an example log information display screen displayed on the displaying unit of the terminal device of the embodiment. The displaying unit 25 displays the log information display screen 111 for presenting the log information received from the server 3 to the user.

The log information display screen 111 illustrated in FIG. 12 is a screen that displays log information of the equipment 1 received by the log information receiver 24. An image 102 showing the identifier, the operating information, the event information, and the time information of the equipment 1 received by the operating information receiver 22 is displayed in an upper part of the log information display screen 111. An image 104 showing the log information of the equipment 1 received by the log information receiver 24 is displayed in a lower part of the log information display screen 111.

Referring back to FIG. 9, if it is determined that the operating information included in the reference request information does not match the comparative operating information (NO in step S23) or the difference between the latest time information included in the reference request information and the current time is not within the predetermined time (NO in step S24), the log information transmitter 35 transmits in step S29 a reference-rejected notice to the terminal device 2 to notice reference to the log information of the equipment 1 is not permitted.

In step S30, the log information receiver 24 of the terminal device 2 receives the reference-rejected notice transmitted by the log information transmitter 35 of the server 3.

In step S31, the displaying unit 25 displays the reference-rejected information indicating that the log information of the equipment 1 cannot be referred to based on the reference-rejected notice received by the log information receiver 24.

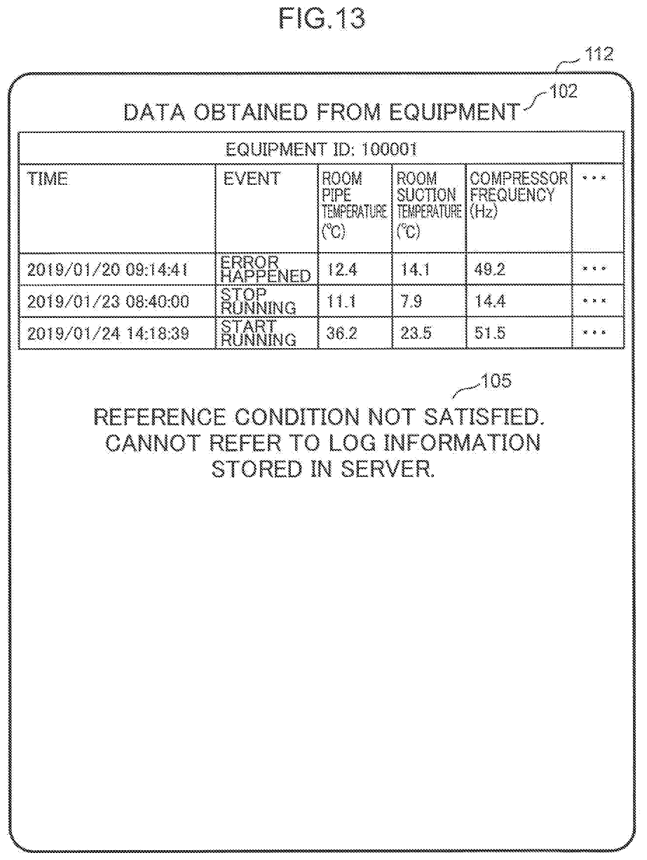

FIG. 13 illustrates an example reference-rejected information display screen displayed on the displaying unit of the terminal device of the embodiment. The displaying unit 25 displays the reference-rejected information display screen 112 for noticing the user that the log information cannot be referred to.

The reference-rejected information display screen 112 illustrated in FIG. 13 displays the reference-rejected information indicating that the log information cannot be referred to based on the reference-rejected notice received by the log information receiver 24. The image 102 showing the identifier, the operating information, the event information, and the time information of the equipment 1 received by the operating information receiver 22 is displayed in an upper part of the reference-rejected information display screen 112. A reference-rejected information 105 for noticing that the log information cannot be referred to based on the reference-rejected notice received by the log information receiver 24 is displayed in a lower part of the reference-rejected information display screen 112.

In step S31, the displaying unit 25 may notice that the log information cannot be referred to and at the same time display manipulation-instructing information instructing the user to manipulate the equipment 1 to get permission to refer to the log information. By instructing the user to manipulate the equipment 1 to make an event happen in the equipment 1, the operating information corresponding to the latest time information is stored in the operating information storing unit 131. The terminal device 2 instructs the user to manipulate the equipment 1 to make an event happen in the equipment 1.

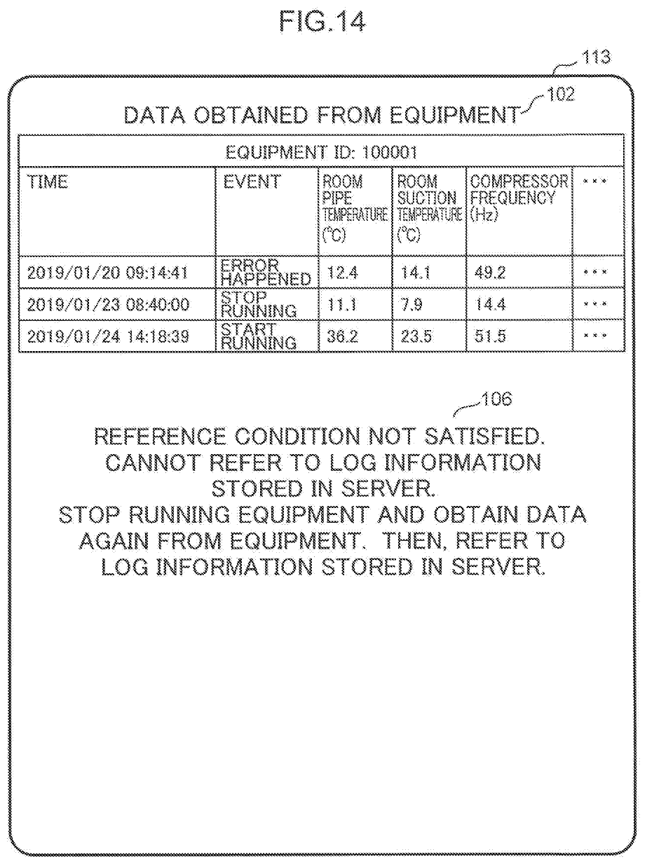

FIG. 14 illustrates an example manipulation-instructing information display screen displayed on the displaying unit of the terminal device of the embodiment. The displaying unit 25 displays the manipulation-instructing information display screen 113 noticing the user that log information cannot be referred to and instructing the user to manipulate the equipment 1 to make an event happen in the equipment 1.

The manipulation-instructing information display screen 113 illustrated in FIG. 14 notices the user based on the reference-rejected notice received by the log information receiver 24 that the log information cannot be referred to and displays the manipulation-instructing information to instruct the user to manipulate the equipment 1. An image 102 showing the identifier, the operating information, the event information, and the time information of the equipment 1 received by the operating information receiver 22 is displayed in an upper part of the manipulation-instructing information display screen 113. A manipulation-instructing information 106 for noticing based on the reference-rejected notice received by the log information receiver 24 that the log information cannot be referred to and instructing the user to manipulate the equipment 1 is displayed in a lower part of the manipulation-instructing information display screen 113.

The manipulation-instructing information 106 illustrated in FIG. 14 includes a message instructing the user to stop running the equipment 1. An event of “stop running” happens by stopping running of the equipment 1, and the operating information corresponding to the latest time information is stored in the operating information storing unit 131. The terminal device 2 obtains operating information newly stored in the operating information storing unit 131 from the equipment 1, and transmits the reference request information including the obtained operating information to the server 3.

After executing displaying processing in step S28 and step S31, the reference control processing performed by the data reference system ends.

In the embodiment, the terminal device 2 obtains from the equipment 1 the operating information of the equipment 1 to be transmitted to the server 3. However, the disclosure is not limited to this configuration. The operating information previously stored in the terminal device 2 may be used.

Alternatively, for example, if the equipment 1 is an air conditioner and the operating information of the equipment 1 is an ambient temperature of the equipment 1, the terminal device 2 may obtain the ambient temperature of the equipment 1 not from the equipment 1 but from a temperature sensor included in the terminal device 2. The terminal device 2 may obtain the ambient temperature of the equipment 1 from a temperature sensor connected to the terminal device 2 wirelessly or by wire to communicate with each other and disposed near the equipment 1. Instead of obtaining operating information from the equipment 1, the terminal device 2 may obtain the operating information of the equipment 1 from a sensor disposed outside the equipment 1.

The terminal device 2 may receive an input, given by the user, of the identifier of the equipment 1 and the operating information of the equipment 1 corresponding to the predetermined time. In this case, the reference request receiver 33 of the server 3 may receive reference request information including the identifier and the operating information of the equipment 1 input by the user. The determining unit 341 may determine whether the predetermined time is included in the predetermined standard period ending at the current time and a difference between the received operating information and the operating information included in the log information of the equipment 1 corresponding to a time in the standard period and accumulated in the server 3 is within a predetermined range. If it is determined that the predetermined time is included in the predetermined standard period ending at the current time and the difference between the received operating information and the operating information included in the log information of the equipment 1 corresponding to a time in the standard period and accumulated in the server 3 is within a predetermined range, the reference controller 342 may permit reference to the log information.

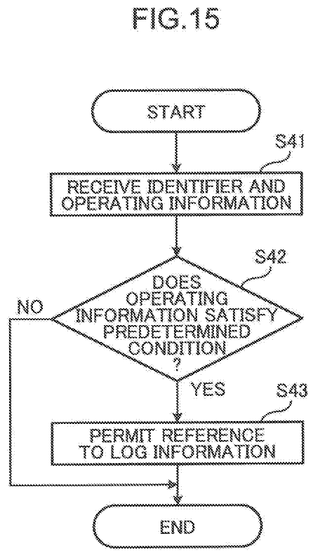

As describe above in the embodiment of the disclosure, the server 3 according to the embodiment controls reference by the terminal device 2 to the log information including the past operating information of the equipment 1. The server 3 performs at least the processing illustrated in FIG. 15.

FIG. 15 is a flowchart for explaining reference control processing performed by the server of the embodiment of the disclosure.

First, in step S41, the server 3 receives an identifier that identifies the equipment 1 and operating information of the equipment 1 corresponding to a predetermined time, the identifier and the operating information being transmitted by the terminal device 2 connected to the server 3 via the network 4.

In step S42, the server 3 determines whether the received operating information satisfies a predetermined condition. The predetermined condition is that the predetermined time is included in a predetermined standard period ending at the current time and the received operating information matches the operating information included in log information of the equipment 1 corresponding to a time in the standard period and accumulated in the server 3.

If it is determined that the received operating information satisfies the predetermined condition (YES in step S42), the server 3 permits the terminal device 2, in step S43, to refer to the log information, accumulated in the server 3, of the equipment 1 corresponding to the identifier corresponding to a time before the predetermined time.

If it is determined that the received operating information does not satisfy the predetermined condition (NO in step S42), the server 3 does not permit the terminal device 2 to refer to the log information of the equipment 1 accumulated in the server 3. The server 3 then ends the reference control processing.

As described above, when the log information of a particular equipment among log information of a plurality of pieces of equipment stored in the server 3 is to be referred to, the terminal device 2 cannot refer to the log information of the particular equipment unless operating information same as the operating information included in the log information of the particular equipment stored in the server 3 is transmitted by the terminal device 2. Thus, if the identifier designating the particular equipment that is to be referred to is wrong, reference to the log information of the equipment corresponding to the wrong identifier is prevented.

Moreover, by adjusting a set value of the standard period, a period in which reference to the log information is permitted can be adjusted, where the set value is compared with a period from a predetermined time associated with the operating information received from the terminal device 2 to the current time. Thus, if a third party bearing an ill intent obtains a portion of the log information stored in the server 3, reference to the log information is not permitted after the standard period has passed even if a portion of the obtained log information is sent to the server 3. This prevents leakage of log information.

Moreover, a portion of the log information stored in the server 3 and the time information included in the log information are used for permitting reference. Thus, a workload of managing permission of reference is reduced while leakage of log information is prevented.

Each components of each embodiment may be a dedicated piece of hardware or may be realized by executing a software program suitable for each component. Each component may be realized by reading and executing a software program stored in a medium, such as a hard disk and a semiconductor memory, by a program executing unit, such as a central processing unit (CPU) and a processor.

A part or all of the functions of the device according to the embodiment of the disclosure is typically realized as a large scale integration (LSI), which is an integrated circuit. These may each be provided as a single chip or a portion or all of them may be included in a single chip. The integrated circuit is not limited to an LSI but may be realized by a dedicated circuit or a general-purpose processor. A field programmable gate way array (FPGA), which is an LSI programmable after manufactured, or a reconfigurable processor in which a connection or setting of a circuit cell inside the LSI is reconfigurable may be used.

A portion or all of the functions of the device according to the embodiment of the disclosure may be realized by executing a program by a processor, such as a CPU.

Values used above are all exemplarily presented to specifically explain the disclosure, so that the disclosure is not limited by the exemplary values.

The order of executing the steps shown in the flowchart is an example for specifically explaining the disclosure. As long as the same effect is obtained, the steps may be executed in an order other than the order described above. A portion of the step may be executed at the same time as the execution of (in parallel with) a different step.

The technique according to the disclosure enables reduction of a workload of managing data used for controlling permission of reference and also prevents leakage of log information. Thus, the technique can be used for controlling reference to log information accumulated in a device.

This application is based on Japanese Patent application No. 2019-094608 filed in Japan Patent Office on May 20, 2019 the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. An information processing method for a server to control reference to accumulated log information of an equipment, the information processing method comprising:
receiving identification information for identifying the equipment and operating information of the equipment corresponding to a predetermined time, the identification information and the operating information being transmitted from a terminal device connected to the server via a network;
determining whether the received operating information satisfies a predetermined condition;
permitting the terminal device, if it is determined that the received operating information satisfies the predetermined condition, to refer to the log information of the equipment accumulated in the server, the log information corresponding to the identification information corresponding to a time before the predetermined time; and
not permitting the terminal device, if it is determined that the received operating information does not satisfy the predetermined condition, to refer to the log information of the equipment accumulated in the server,
wherein
the predetermined condition is that the predetermined time is included in a predetermined standard period ending at a current time and the received operating information matches operating information included in the log information of the equipment corresponding to a time in the standard period and accumulated in the server.

2. The information processing method according to claim 1, wherein
the terminal device is configured to receive an input of the operating information of the equipment corresponding to the predetermined time, the input being given by an user,
the receiving is receiving of the identification information and the operating information input by the user, and
the predetermined condition is that the predetermined time is included in the predetermined standard period ending at the current time and a difference between the received operating information and the operating information included in the log information of the equipment corresponding to the time in the standard period and accumulated in the server, is within a predetermined range.

3. The information processing method according to claim 1, wherein
the operating information included in the log information accumulated in the server includes sensor information obtained by the server from the equipment, and
the operating information received from the terminal device includes sensor information obtained by the terminal device from the equipment.

4. The information processing method according to claim 1, wherein,
if operating information corresponding to a time same as the predetermined time does not exist in the log information, the determining of whether the predetermined condition is satisfied is made by deriving a plurality of pieces of operating information from the log information, interpolating operating information corresponding to the predetermined time using the derived plurality of pieces of operating information, and determining whether the received operating information matches the interpolated operating information.

5. The information processing method according to claim 4, wherein
the receiving is receiving of the identification information, the operating information, and event information for identifying an event happened at the predetermined time in the equipment, and,
if the operating information corresponding to the time same as the predetermined time does not exist in the log information, the determining of whether the predetermined condition is satisfied is made by obtaining an operating property of the equipment corresponding to the event information, deriving a plurality pieces of operating information from the log information, and interpolating operating information corresponding to the predetermined time using the obtained operating property and the derived plurality of pieces of operating information.

6. The information processing method according to claim 1, further comprising:
transmitting the log information to the terminal device if reference to the log information is permitted.

7. The information processing method according to claim 1, further comprising:
transmitting information instructing a user to manipulate the equipment to the terminal device if reference to the log information is not permitted.

8. A server that controls reference to accumulated log information of an equipment, the server comprising:
a receiver configured to receive identification information for identifying the equipment and operating information of the equipment corresponding to a predetermined time, the identification information and the operating information being transmitted from a terminal device connected to the server via a network;
a determining unit configured to determine whether the received operating information satisfies a predetermined condition; and
a reference controller configured to permit the terminal device, if it is determined that the received operating information satisfies the predetermined condition, to refer to the log information of the equipment accumulated in the server, the log information corresponding to the identification information corresponding to a time before the predetermined time, and not permit the terminal device, if it is determined that the received operating information does not satisfy the predetermined condition, to refer to the log information of the equipment accumulated in the server,
wherein
the predetermined condition is that the predetermined time is included in a predetermined standard period ending at a current time and the received operating information matches operating information included in the log information of the equipment corresponding to a time in the standard period and accumulated in the server.

9. A non-transitory computer-readable recording medium recording an information processing program for controlling reference to accumulated log information of an equipment, the information processing program causing a computer to execute:
receiving identification information for identifying the equipment and operating information of the equipment corresponding to a predetermined time, the identification information and the operating information being transmitted from a terminal device connected to the server via a network;
determining whether the received operating information satisfies a predetermined condition;
permitting the terminal device, if it is determined that the received operating information satisfies the predetermined condition, to refer to the log information of the equipment accumulated in the server, the log information corresponding to the identification information corresponding to a time before the predetermined time; and
not permitting the terminal device, if it is determined that the received operating information does not satisfy the predetermined condition, to refer to the log information of the equipment accumulated in the server,
wherein
the predetermined condition is that the predetermined time is included in a predetermined standard period ending at a current time and the received operating information matches operating information included in the log information of the equipment corresponding to a time in the standard period and accumulated in the server.
